(19) United States
(12) Patent Application Publication
(10) Pub. No.: US 2016/0308379 A1
(43) Pub. Date: Oct. 20, 2016

(54) MULTI-APPLICATION VEHICLE EMERGENCY RESCUE STARTER

(71) Applicant: C-TECH UNITED CORP., New Taipei City (TW)

(72) Inventor: Hsin-Tai PAN, New Taipei City (TW)

(21) Appl. No.: 14/688,567

(22) Filed: Apr. 16, 2015

(51) Int. Cl. H02J 7/00

(52) U.S. Cl. CPC H02J 7/0042

(57) ABSTRACT

A multi-application vehicle emergency rescue starter includes a housing holding therein a battery and a charging circuit, and an output end located at one side of the housing and electrically coupled with the battery and the charging circuit. The output end includes a first starter power outlet for the connection of a jumper cable, a second starter power outlet for the connection of a power cable for vehicle emergency rescue device, and a USB connector electrically coupled with the battery and the charging circuit and adapted for charging a battery of a mobile electronic device through a USB cable.

### BACKGROUND OF THE INVENTION

1. Field of the Invention

The present invention relates to vehicle battery charging technology and more particularly, to a multi-application vehicle emergency rescue starter, which is practical for charging different batteries of different motor vehicles and mobile electronic devices.

2. Description of the Related Art

If a car cannot be started due to battery low or aged battery, the normal emergency rescue procedure is to charge the car battery with an external power source. When charging the car battery, the user needs to open the engine compartment lid, and then disconnect the battery wires, and then fasten battery clamps of a jumper cable to the positive and negative terminals of the car battery to charge the car battery with an external power source. Due to the constraint of current limit, this car battery charging operation must be performed by a technician or skilled person.

In order to let ordinary people charge the car battery, specific voltage car battery chargers are created. These car battery chargers are designed for easy use by ordinary people. Through technology evolving, a specific voltage car battery charger is configured to provide a power cable for connection to a cigarette lighter receptacle in a car to charge the battery of the car, simplifying the car battery charging procedure and enhancing charging safety.

However, a car battery charger or emergency rescue starter equipped with a power cable connectable to cigarette lighter receptacle in a car simply provides one single electrical outlet for the connection of the power cable, i.e., a car battery charger or emergency rescue starter of this design is not connectable to the battery terminals of a car battery, limiting its application range. An improvement in this regard is desired.

### SUMMARY OF THE INVENTION

The present invention has been accomplished under the circumstances in view. It is the main object of the present invention to provide a multi-application vehicle emergency rescue starter, which is practical for charging different batteries of different motor vehicles and mobile electronic devices.

To achieve this and other objects of the present invention, a multi-application vehicle emergency rescue starter comprises a housing holding therein a battery and a charging circuit, and an output end located at one side of the housing and electrically coupled with the battery and the charging circuit. The output end comprises a first starter power outlet for the connection of a jumper cable, and a second starter power outlet for the connection of a power cable for vehicle emergency rescue device.

Preferably, a USB connector is installed in the output end of the multi-application vehicle emergency rescue starter and electrically coupled with the battery and the charging circuit for charging a battery of a mobile electronic device through a USB cable.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 illustrates an oblique top elevational view of a multi-application vehicle emergency rescue starter in accordance with the present invention.

FIG. 2 is a schematic exploded view illustrating the connection application of a jumper cable and a power cable relative to the first starter power outlet and second starter power outlet of the output end of the multi-application vehicle emergency rescue starter in accordance with the present invention.

FIG. 3 illustrates an application example of the multi-application vehicle emergency rescue starter in accordance with the present invention.

FIG. 4 illustrates another application example of the multi-application vehicle emergency rescue starter in accordance with the present invention.

FIG. 5 is an oblique top elevational view of an alternate form of the multi-application vehicle emergency rescue starter in accordance with the present invention.

### DETAILED DESCRIPTION OF THE PREFERRED EMBODIMENT

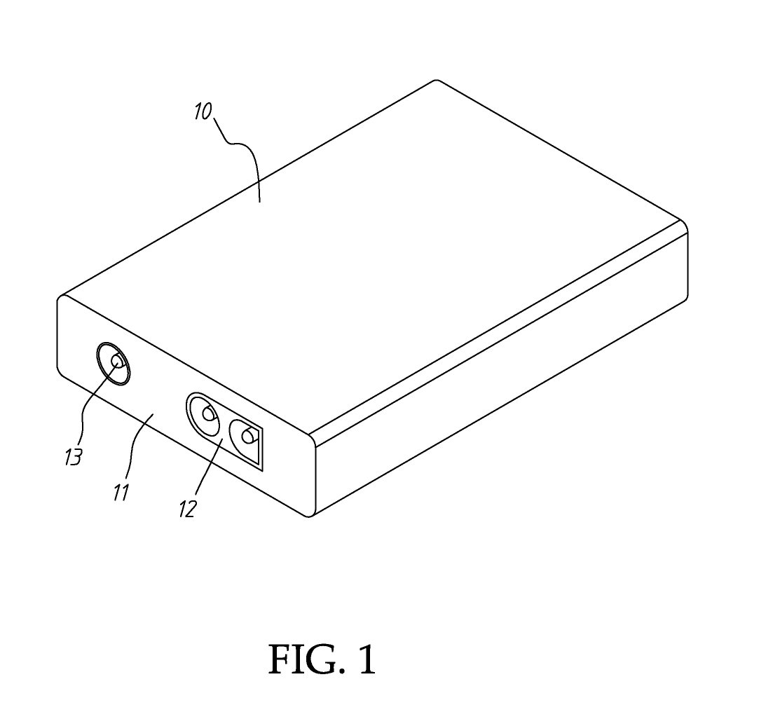

Referring to FIG. 1, a multi-application vehicle emergency rescue starter in accordance with the present invention is shown. The multi-application vehicle emergency rescue starter comprises a housing 10 holding therein a battery and a charging circuit, and an output end 11 located at one side of the housing 10 and electrically coupled with the battery and charging circuit in the housing.

The output end 11 comprises a first starter power outlet 12 for the connection of a jumper cable, and a second starter power outlet 13 for the connection of a power cable for vehicle emergency rescue device.

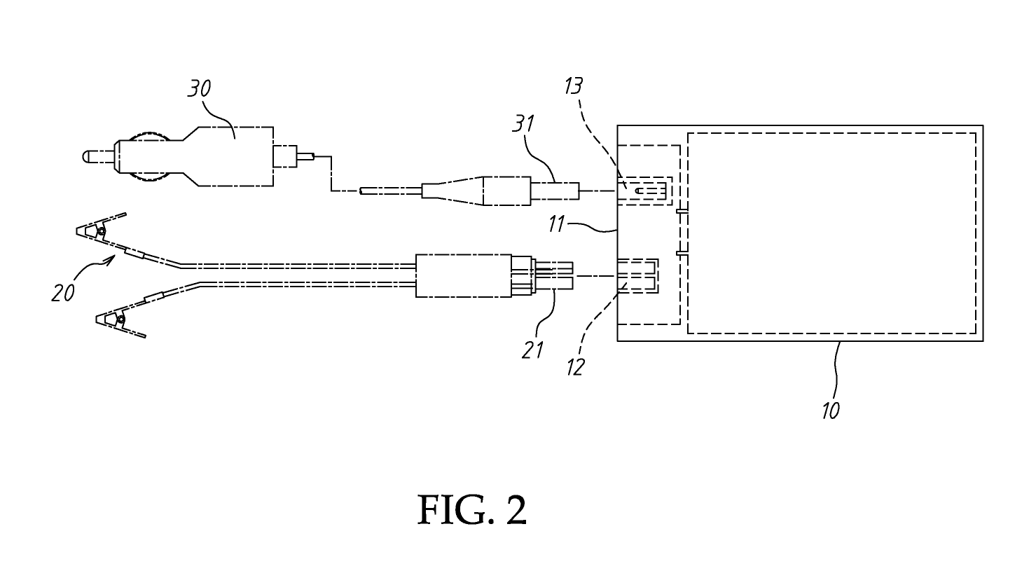

Referring to FIG. 2, the first starter power outlet 12 of the output end 11 is adapted for the connection of a plug 21 of a jumper cable 20 that can be connected to the battery terminals of the vehicle battery of an external motor vehicle for enabling the multi-application vehicle emergency rescue starter to charge the vehicle battery; the second starter power outlet 13 of the output end 11 is adapted for the connection of a connection terminal 31 of a power cable 30 for vehicle emergency rescue device.

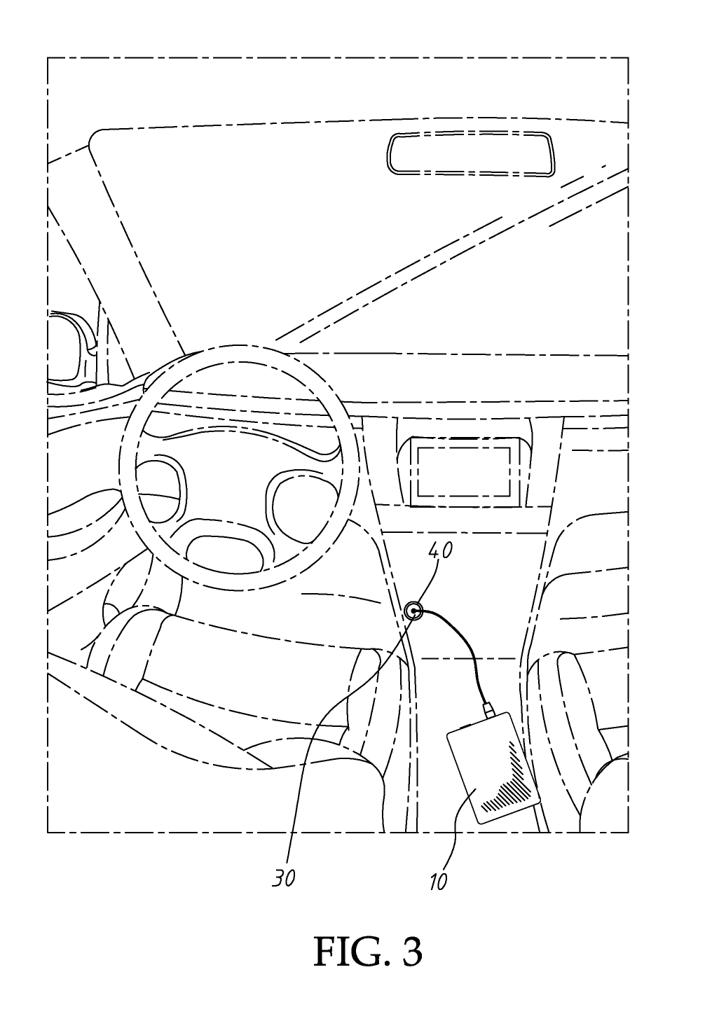

Referring to FIG. 3, in one application example of the present invention, a power cable 30 is connected with its one end to cigarette lighter receptacle in a motor vehicle and with a connection terminal 31 at its other end connected to the second starter power outlet 13 of the output end 11 of the multi-application vehicle emergency rescue starter for enabling the multi-application vehicle emergency rescue starter to provide electricity to the motor vehicle.

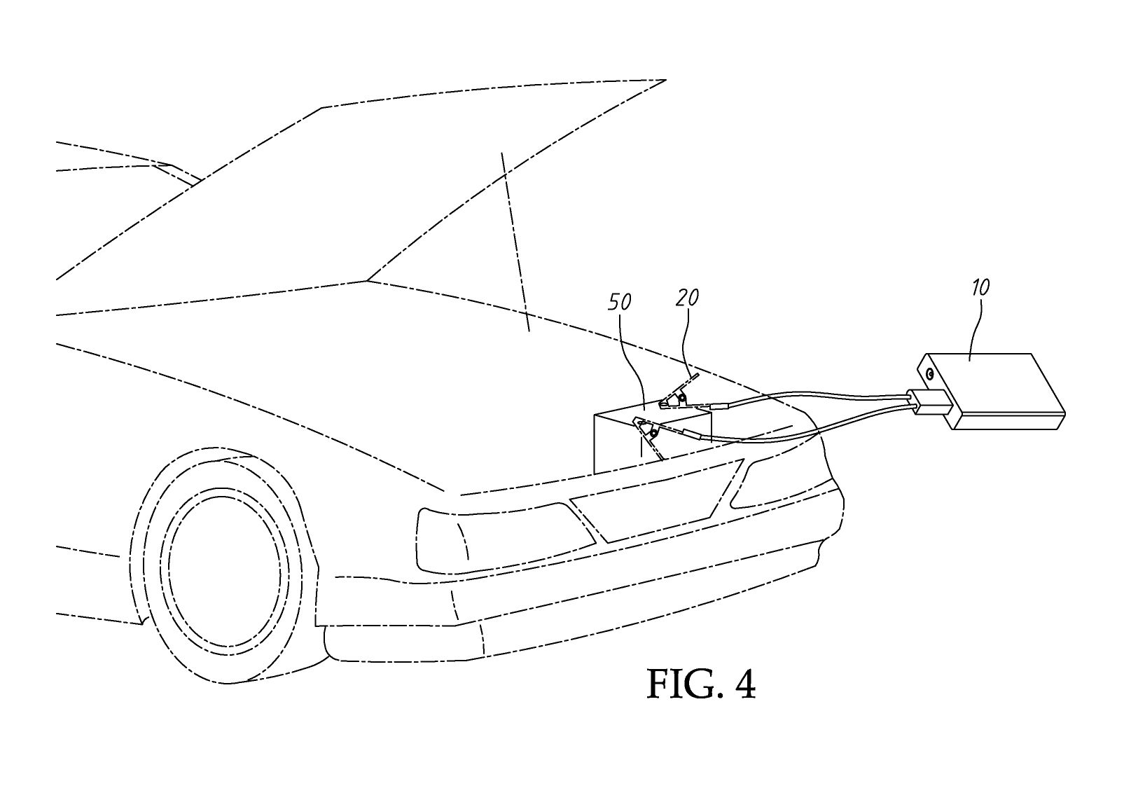

Referring to FIG. 4, in another application example of the present invention, a jumper cable 20 is connected with its terminal clamps at its one end to the battery terminals of the vehicle battery of a motor vehicle and with its plug 21 at its other end connected to the first starter power outlet 12 of the output end 11, enabling the multi-application vehicle emergency rescue starter to charge the vehicle battery of the motor vehicle.

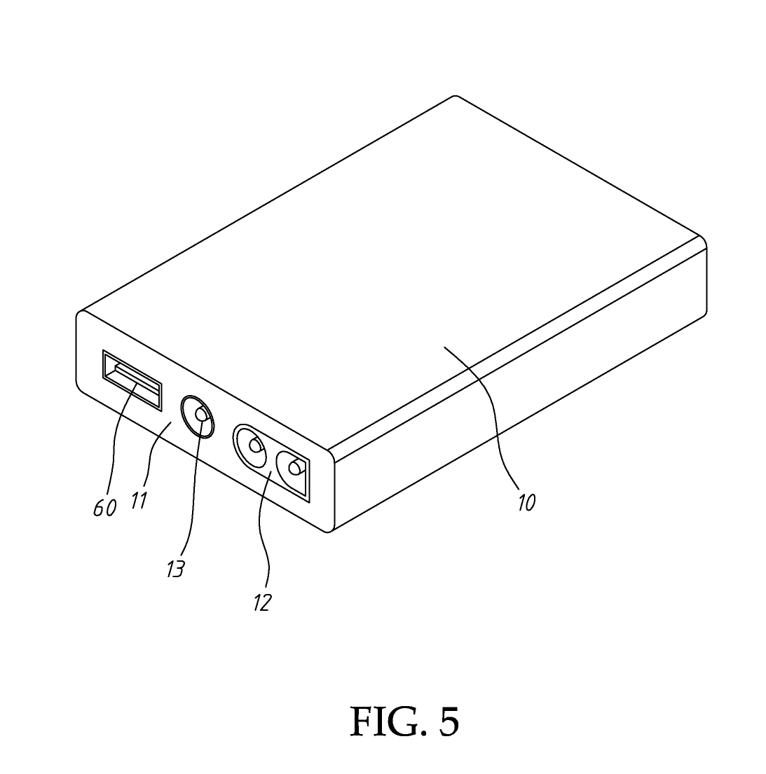

Referring to FIG. 5, the multi-application vehicle emergency rescue starter can be configured to provide a USB connector 60 at output end 11 for the connection of a mobile electronic device through a USB cable for emergency battery charging.

In conclusion, the invention provides a multi-application vehicle emergency rescue starter, which comprises two starter power outlets for the connection of different types of power cables for charging the battery of any of a variety of motor vehicles and other mobile electronic devices.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A multi-application vehicle emergency rescue starter, comprising a housing holding therein a battery and a charging circuit, and an output end located at one side of said housing and electrically coupled with said battery and said charging circuit, wherein said output end comprises a first starter power outlet for the connection of a jumper cable, and a second starter power outlet for the connection of a power cable for vehicle emergency rescue device.

2. The multi-application vehicle emergency rescue starter as claimed in claim 1, wherein said output end further comprises a USB connector electrically coupled with said battery and said charging circuit and adapted for charging a battery of a mobile electronic device through a USB cable.
